(19) United States
(12) Patent Application Publication
(10) Pub. No.: US 2002/0182572 A1
(43) Pub. Date: Dec. 5, 2002

(54) Sanitation department educational toy

(76) Inventor: Steve Steurenthal, Brooklyn, NY (US)

Correspondence Address: Richard W. Goldstein, 2071 Clove Road, Staten Island, NY, 10304, US

(21) Appl. No.: 09/871,802

(22) Filed: Jun. 1, 2001

(51) Int. Cl. G09B 19/00

(52) U.S. Cl. 434/219

(57) ABSTRACT

A sanitation department educational toy including a plurality of action figurines representing sanitation workers. A plurality of cleaning implements are also included as well as a plurality of sanitation vehicles. The action figurines, cleaning implements, and sanitation vehicles can all be arranged and used to simulate daily activities of sanitation workers.

### BACKGROUND OF THE INVENTION

The present invention relates to a sanitation department educational toy and more particularly pertains to educating youth about the functions of the sanitation department.

The use of toys and games is known in the prior art. More specifically, toys and games heretofore devised and utilized for the purpose of providing education and amusement are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,917,648 to Hartje discloses a battery-operated toy sanitation truck for use by a child in simulative cleaning. U.S. Pat. No. 5,435,768 to Dunleavy discloses a miniature model trash truck with a front fork and dumping means. U.S. Pat. No. 5,366,227 to Duffy discloses a recycling game comprised of a toy vehicle with a plurality of marked bins for dividing refuse.

While these devices fulfill their respective, particular objective and requirements, the aforementioned patents do not describe a sanitation department educational toy for educating youth about the functions of the sanitation department.

In this respect, the sanitation department educational toy according to the present invention substantially departs from the conventional concepts and designs of the prior art, and in doing so provides an apparatus primarily developed for the purpose of educating youth about the functions of the sanitation department.

Therefore, it can be appreciated that there exists a continuing need for a new and improved sanitation department educational toy which can be used for educating youth about the functions of the sanitation department. In this regard, the present invention substantially fulfills this need.

### SUMMARY OF THE INVENTION

In the view of the foregoing disadvantages inherent in the known types of toys and games now present in the prior art, the present invention provides an improved sanitation department educational toy. As such, the general purpose of the present invention, which will be described subsequently in greater detail, is to provide a new and improved sanitation department educational toy which has all the advantages of the prior art and none of the disadvantages.

To attain this, the present invention essentially comprises a plurality of action figurines representing sanitation workers. A plurality of cleaning implements are also included as well as a plurality of sanitation vehicles. The action figurines, cleaning implements, and sanitation vehicles can all be arranged and used to simulate daily activities of sanitation workers.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved sanitation department educational toy which has all the advantages of the prior art toys and games and none of the disadvantages.

It is another object of the present invention to provide a new and improved sanitation department educational toy which may be easily and efficiently manufactured and marketed.

It is a further object of the present invention to provide a new and improved sanitation department educational toy which is of durable and reliable construction.

An even further object of the present invention is to provide a new and improved sanitation department educational toy which is susceptible of a low cost of manufacture with regard to both materials and labor, and which accordingly is then susceptible of low prices of sale to the consuming public, thereby making such a sanitation department educational toy economically available to the buying public.

Even still another object of the present invention is to provide a new and improved sanitation department educational toy for educating youth about the functions of the sanitation department.

Lastly, it is an object of the present invention to provide a new and improved sanitation department educational toy including a plurality of action figurines representing sanitation workers. A plurality of cleaning implements are also included as well as a plurality of sanitation vehicles. The action figurines, cleaning implements, and sanitation vehicles can all be arranged and used to simulate daily activities of sanitation workers.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the sanitation department educational toy constructed in accordance with the principles of the present invention.

FIG. 2 is a perspective view of the sanitation vehicles of the present invention.

The same reference numerals refer to the same parts through the various figures.

### DESCRIPTION OF THE PREFERRED EMBODIMENT

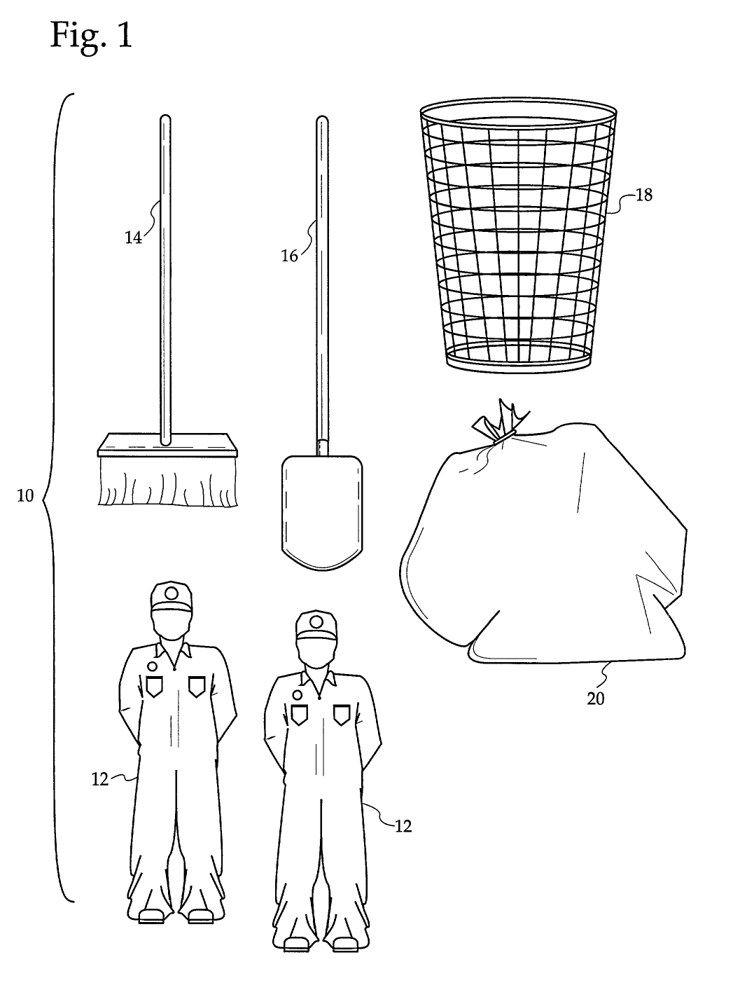

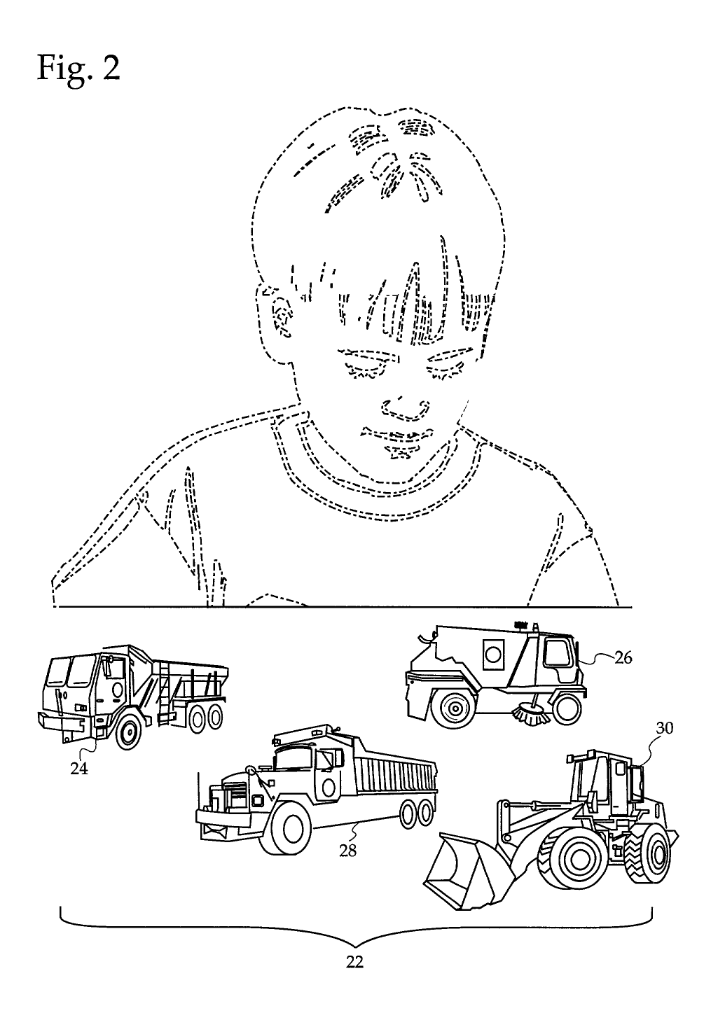

With reference now to the drawings, and in particular, to FIGS. 1 and 2 thereof, the preferred embodiment of the new and improved sanitation department educational toy embodying the principles and concepts of the present invention and generally designated by the reference number 10 will be described.

Specifically, it will be noted in the various Figures that the device relates to a sanitation department educational toy for educating youth about the functions of the sanitation department. In its broadest context, the device consists of a plurality of action figurines, a plurality of cleaning implements, and a plurality of sanitation vehicles. Such components are individually configured and correlated with respect to each other so as to attain the desired objective.

The plurality of action figurines 12 represent sanitation workers. Note FIG. 1. The figurines 12 are dressed in coveralls and wear hats to similarly depict an actual sanitation worker. The coveralls could be imprinted with indicia to identify the type of sanitation worker.

The plurality of cleaning implements specifically included in the present invention are a broom 14, a shovel 16, a garbage receptacle 18, and a garbage-filled trash bag 20. Note FIG. 1. It should be noted that other types of cleaning implements normally associated with the daily routines of sanitation workers could also be included with the present invention.

The plurality of sanitation vehicles 22 used in the present invention, and illustrated in FIG. 2, include, but are not limited to, sand trucks 24, street sweeper's 26, garbage trucks 28, and front end loaders 30. The vehicles 22 are all small enough to allow a child to easily handle.

The action figurines 12, cleaning implements, and sanitation vehicles 22 can all be arranged and used to simulate daily activities of sanitation workers.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the united states is as follows:

1. A sanitation department educational toy for educating youth about the functions of the sanitation department comprising, in combination:
a plurality of action figurines representing sanitation workers;
a plurality of cleaning implements;
a plurality of sanitation vehicles; and
whereby the action figurines, cleaning implements, and sanitation vehicles can all be arranged and used to simulate daily activities of sanitation workers.

2. The sanitation department educational toy as set forth in claim 1, wherein the cleaning implements include brooms and shovels.

3. The sanitation department educational toy as set forth in claim 1, wherein the sanitation vehicles include sand trucks, street sweepers, garbage trucks, and front end loaders.

4. The sanitation department educational toy as set forth in claim 1, wherein the plurality of sanitation vehicles are sized for being held by a child.

5. The sanitation department educational toy as set forth in claim 1, wherein the cleaning implements include a trash receptacle and a trash-filled garbage bag.
